(19) United States
(12) Patent Application Publication
(10) Pub. No.: US 2011/0251052 A1
(43) Pub. Date: Oct. 13, 2011

(54) CATALYST FOR THE OXIDATION OF SO2 TO SO3

(75) Inventors: Michael Kramer, Mannheim (DE); Markus Schubert, Ludwigshafen (DE); Thomas Lautensack, Alteiningen (DE); Thomas Hill, Ludwigshafen (DE); Reinhard Korner, Frankenthal (DE); Frank Rosowski, Mannheim (DE); Jurgen Zuhlke, Speyer (DE)

(73) Assignee: BASF SE, Ludwigshafen (DE)

(21) Appl. No.: 13/083,055

(22) Filed: Apr. 8, 2011

Related U.S. Application Data
(60) Provisional application No. 61/322,944, filed on Apr. 12, 2010.

(51) Int. Cl. B01J 27/055

(52) U.S. Cl. 502/218

(57) ABSTRACT

The invention relates to a catalyst for the oxidation of SO₂ to SO₃ and also a process for producing it and its use in a process for the oxidation of SO₂ to SO₃.

### CROSS-REFERENCE TO RELATED APPLICATIONS

This application claims benefit (under 35 USC 119(e)) of U.S. Provisional Application 61/322,944, filed Apr. 12, 2010 which is incorporated by reference.

### BACKGROUND OF THE INVENTION

The invention relates to a catalyst for the oxidation of SO₂ to SO₃ and also a process for producing it and its use in a process for the oxidation of SO₂ to SO₃.

Sulfuric acid is nowadays obtained virtually exclusively by oxidation of sulfur dioxide (SO₂) to sulfur trioxide (SO₃) in the contact/double contact process with subsequent hydrolysis. In this process, SO₂ is oxidized to SO₃ by means of molecular oxygen over vanadium-comprising catalysts in a plurality of adiabatic layers (beds) arranged in series. The SO₂ content of the feed gas is usually in the range from 0.01 to 50% by volume and the ratio of O₂/SO₂ is in the range from 0.5 to 5. A preferred oxygen source is air. Part of the sulfur dioxide is reacted in the individual beds, with the gas in each case being cooled between the individual beds (contact process). SO₃ formed can be removed from the gas stream by intermediate absorption in order to achieve higher total conversion (double contact process). The reaction is, depending on the bed, carried out in a temperature range from 340° C. to 680° C., with the maximum temperature decreasing with increasing bed number owing to the decreasing SO₂ content.

Present-day commercial catalysts usually comprise the active component vanadium pentoxide (V₂O₅) together with alkali metal oxides (M₂O), especially potassium oxide K₂O but also sodium oxide Na₂O and/or cesium oxide Cs₂O, and also sulfate. Porous oxides such as silicon dioxide SiO₂ are usually used as supports for the abovementioned components. Under the reaction conditions, an alkali metal pyrosulfate melt is formed on the support material and the active component dissolves in this in the form of oxo sulfate complexes (Catal. Rev.—Sci. Eng., 1978, vol 17 (2), pages 203 to 272). The catalyst is referred to as a supported liquid phase catalyst.

The contents of V₂O₅ are usually in the range from 3 to 10% by weight, and the contents of alkali metal oxides are, depending on the species used and the combination of various alkali metals, in the range from 6 to 26% by weight, with the molar ratio of alkali metal to vanadium (MN ratio) usually being in the range from 2 to 5.5. The K₂O content is usually in the range from 7 to 14% by weight and the sulfate content is in the range from 12 to 30% by weight. In addition, the use of numerous further additional elements, for example chromium, iron, aluminum, phosphorus, manganese and boron, has been reported. As porous support material, use is made predominantly of SiO₂.

Such catalysts are usually produced on an industrial scale by mixing aqueous solutions or suspensions of the various active components, for example appropriate vanadium compounds (V₂O₅, ammonium vanadate, alkali metal vanadates or vanadyl sulfates) with alkali metal salts (nitrates, carbonates, oxides, hydroxides, sulfates), sometimes together with sulfuric acid and other components which can function as pore formers or lubricants, for example sulfur, starch or graphite, with the support material. The resulting viscous composition is processed to give the desired shaped bodies in the next step and finally subjected to thermal treatment (drying and calcination).

The properties of the catalyst are determined firstly by the active composition content, the type and amount of the alkali metal used, the MN ratio and the use of any further promoters and secondly also by the type of support material used. A support material which is stable under reaction conditions helps to increase the surface area of the melt and thus the number of accessible dissolved active component complexes. The pore structure of the support material is of central importance here. Small pores stabilize the liquid state and therefore reduce the melting point of the salt melt (React. Kinet. Catal. Lett., 1986, vol. 30 (1), pages 9 to 15) and also produce a particularly high surface area. Both effects lead to increased reactivity in the lower temperature range, i.e. according to the assignment in DD92905, in the temperature range <400° C. Large pores are particularly relevant at high temperatures (reaction temperatures of >440° C.) in order to avoid transport limitation.

Apart from the catalytic activity of a catalyst, its life is also of tremendous importance. The life is influenced firstly by poisons which get into the reactor both from the outside together with the feed gas and gradually accumulate in the bed and also via impurities which are comprised in the starting materials such as the silicon dioxide support and become mobile under reaction conditions and can react with sulfate ions and thus have an adverse effect on the properties of the catalyst. Examples of such impurities are alkaline earth metal compounds (e.g. calcium compounds), iron compounds or aluminum compounds. In addition, the catalyst can also simply sinter under extreme conditions and thus gradually lose its active surface area. The pressure drop over the bed is also of very particular importance; this should be very low and increase very little over the life of the catalyst. For this purpose, it is necessary for a freshly produced catalyst to have very good mechanical properties. Typical parameters measured for this purpose are, for example, the abrasion resistance or the resistance to penetration of a cutter (cutting hardness). In addition, the tapped density of the catalyst also plays a central role since only in this way can it be ensured that a particular, necessary mass of active composition is introduced into the given reactor volume.

As inert materials for commercial sulfuric acid catalysts, use is made predominantly of inexpensive, porous materials based on SiO₂. Both synthetic variants of SiO₂ and natural forms of SiO₂ are used here.

Synthetic variants generally enable the desired support properties such as pore structure or mechanical stability to be set appropriately. RU 2186620 describes, for example, the use of precipitated silica gel as support for a sulfuric acid catalyst. DE 1235274 discloses a process for the oxidation of SO₂ using a catalyst based on V₂O₅/K₂O/SiO₂, wherein catalysts having an appropriately matched pore microstructure are used at different working temperatures. These compounds can be obtained, for example, by use of particular synthetic SiO₂ components such as precipitated sodium water glass. SU 1616-688 describes the use of amorphous synthetic SiO₂ having a high surface area. However, such components have the disadvantage of relatively high production and materials costs.

For this reason, naturally occurring silicon dioxides (also referred to as kieselguhr or diatomaceous earth), which as natural product can be obtained significantly more cheaply but often deviates in terms of their properties from the desired optimum, are frequently used in industrial practice. The authors of SU 1803180 use kieselguhr as support for such a catalyst. CN 1417110 discloses a catalyst for the oxidation of SO₂ which is based on V₂O₅ and K₂SO₄ and in which the kieselguhr used originates from a particular province in China.

The properties of a sulfuric acid catalyst can also be influenced by the type of pretreatment of the pure natural support material. Fedoseev et al. report, for example, modification of the pore structure (shift of the maximum to smaller pores) of a vanadium-based sulfuric acid catalyst by mechanical comminution of the kieselguhr (Sbornik Nauchnykh Trudov—Rossiiskii Khimiko—Tekhnologicheskii Universitet im. D. I. Mendeleeva (2000), (178, Protsessy i Materialy Khimicheskoi Promyshlennosti), 34-36 CODEN: SNTRCV). This results in improved mechanical stability. Disadvantages of this modification are firstly the use of an additional working step (comminution of the support for 12 h) and secondly the reduced catalytic activity resulting therefrom.

SU 1824235 describes a catalyst for the oxidation of SO₂ to SO₃ for a high-temperature process, wherein the kieselguhr support used comprises from 10 to 30% by weight of clay minerals and is calcined at from 600 to 1000° C. and subsequently comminuted before mixing with the actual active components, where at least 40% of the calcined kieselguhr has a particle diameter of <10 μm. In this example, too, an additional working step (comminution) is necessary.

Numerous documents describe optimization of the catalyst properties by joint use of natural and synthetic SiO₂ variants. DE 400609 discloses a catalyst for the oxidation of SO₂ which comprises vanadium compounds and alkali metal compounds on a support material having a defined pore structure, wherein different SiO₂ components having different pore diameters are mixed with one another in defined ratios so that the resulting support has a high proportion of pores having a diameter of <200 nm. A similar approach is followed in WO 2006/033588, WO 2006/033589 and RU 2244590. There, catalysts for the oxidation of SO₂ which are based on V₂O₅, alkali metal oxides, sulfur oxide and SiO₂ and have an oligomodal pore distribution matched to the respective working temperature range are described. Such a defined pore microstructure can be set, for example, by combining synthetic silicon dioxide with natural kieselguhr. RU 2080176 describes a positive effect on the hardness and activity of a sulfuric acid catalyst based on V₂O₅/K₂O/SO₄/SiO₂ by an addition of SiO₂ waste obtained in the production of silicon to the kieselguhr. A similar effect is found in SU 1558-463 as a result of the addition of silica sols to the kieselguhr.

U.S. Pat. No. 1,952,057, FR 691356, GB 337761 and GB 343441 describe combined use of natural kieselguhr with synthetic SiO₂ in the form of the appropriate potassium water glasses. The synthetic silicon component is applied from an aqueous solution to the kieselguhr, for example by precipitation, so that the ultimate result is SiO₂-encased kieselguhr particles which can be impregnated with the appropriate active components. The catalysts produced in this way display improved properties such as hardness or catalytic activity.

DE 2500264 discloses a vanadium-based catalyst for the oxidation of SO₂, where a mixture of kieselguhr with asbestos and bentonite is admixed with potassium water glass solution and is then used as support component having increased mechanical stability.

Apart from exclusive use of synthetic or natural SiO₂ variants or use of a mixture of synthetic and natural SiO₂ variants, it is also possible to use mixtures of different natural SiO₂ variants. Jíru and Brüll describe modification of the pore structure of a particular type of kieselguhr by addition of 30% by weight of coarse kieselguhr waste from the same support, which led to a shift in the average pore diameter from 56 nm to 80 nm (Chemicky Prumysl (1957), 7, 652-4 CODEN: CHPUA4; ISSN: 0009-2789). PL 72384 claims an SiO₂ support based on natural kieselguhr for a vanadium catalyst, wherein 20-35% of the particles of the support are in the range from 1 to 5 μm, 10-25% are in the range from 5 to 10 μm, 10-25% are in the range from 20 to 40 μm, 10-25% are in the range from 40 to 75 μm and 1-7% are larger than 75 μm and the support is produced by calcination of the kieselguhr at 900° C. with subsequent mixing with the uncalcined kieselguhr in a ratio of from 1:1 to 1:4. DE 2640169 describes a vanadium-based sulfuric acid catalyst which has a high stability and effectiveness and in which a finely divided fresh water diatomaceous earth comprising at least 40% by weight of a calcined diatomaceous earth formed from the siliceous algae Melosira granulata is used as support, where the diatomaceous earth has been calcined at a temperature in the range from 510 to 1010° C. before mixing with the active component, suitable accelerators and promoters. The catalysts produced in this way have a higher catalytic activity and mechanical stability than catalysts which comprise exclusively the corresponding diatomaceous earth in uncalcined and/or uncomminuted form, regardless of whether the proportion of diatomaceous earth to be comminuted is milled before or after calcination.

It is therefore known that diatomaceous earths of the same type which have been subjected to different pretreatments can be mixed with one another or with synthetic SiO₂ components in order to optimize the properties of sulfuric acid catalysts. Disadvantages of the use of mixtures of calcined and uncalcined kieselguhrs as supports for sulfuric acid catalysts are firstly the necessity of a further process step (calcination of the kieselguhr) and also the possible conversion of amorphous SiO₂ form into the cristobalite modification which is problematical in terms of human health.

Diatomaceous earths (also known as kieselguhrs) are naturally occurring silicon dioxide shells of fossil siliceous algae (diatoms), which are generally classified according to the structure of the siliceous algae on which they are based (cf. Adl et al., Journal of Eukaryotic Microbiology, 2005, vol. 52, page 399). This classification is based on the architecture of the siliceous shells of the algae (frustule), i.e. for example on the basis of their size or symmetry. On the basis of this symmetry, the siliceous algae can be classified into radially symmetric centrals and bilaterally symmetric pennales. The pennales are further differentiated according to the presence of a raphe, an organ of movement, and also its configuration. The centrals are further classified according to the shape of the cells in plan view: there are, for example, plate-shaped variants such as the Coscinodicineae, which are characterized by a round, plate-shaped geometry (in plan view) without projections, with the height being less than the diameter of the shell, and have a convex side view. There are also diatoms which have an often elongated, cylindrical shell and usually appear rectangular in side view, for example the types Aulacoseira or Melosira. Further representatives of siliceous algae are, for example, the rod-shaped Asterionella, the Eunotia whose long shell is curved, the boat-shaped Navicula or the elongated Nitzschia.

Interestingly, the structure types found in the known deposits of diatomaceous earths are very uniform, so that in a particular diatomaceous earth predominantly only one form of siliceous algae can be recognized. Commercially available diatomaceous earths of the type Celite 209 (California), Celite 400 (Mexico), Masis (Armenia), AG-WX1 (China), AG-WX3 (China), CY-100 (China) have, for example, predominantly plate-shaped structures (which originate, for example, from Coscinodicineae), while the materials of the type MN, FN2-Z or LCS mined in North America (in Nevada or Oregon) by EP Minerals LLC comprise predominantly cylindrical forms (Melosira). FIGS. 1 and 2 show scanning electron micrographs of commercially available diatomaceous earths (Masis and Celite 400) which are based predominantly on plate-shaped siliceous algae. FIG. 3 shows a corresponding micrograph of a diatomaceous earth derived from cylindrical siliceous algae of the Melosira type. In addition, diatomaceous earths which have none of the above-described symmetries are also found, e.g. the rod-shaped diatomaceous earth of the Diatomite 1 type occurring in Peru and mined by Mineral Resources Co. or the rod-shaped Tipo type mined by CIEMIL in Brazil. FIG. 4 shows a scanning electron micrograph of a corresponding diatomaceous earth (Diatomite 1).

### BRIEF SUMMARY OF THE INVENTION

It was an object of the present invention to provide a catalyst for the oxidation of SO₂ to SO₃, which can be used in a very wide temperature range and can be produced very economically and has, in particular, improved mechanical stability.

This object is achieved by a catalyst having a support containing at least two different uncalcined diatomaceous earths which originate from different geographic deposits and thus from different structure types of siliceous algae.

The invention therefore provides a catalyst for the oxidation of SO₂ to SO₃, which comprises active substance comprising vanadium, alkali metal compounds and sulfate applied to a support comprising naturally occurring diatomaceous earth, wherein the support comprises at least two different naturally occurring uncalcined diatomaceous earths which differ in terms of the structure type of the siliceous algae from which they are derived.

### A BRIEF DESCRIPTION OF THE FIGURES

FIGS. 1 and 2 show scanning electron micrographs of commercially available diatomaceous earths (Masis from Diatomite SP CJSC, Armenia and Celite 400 from Lehmann & Voss & Co.) which are based predominantly on plate-shaped siliceous algae similar to or of the Coscinodicineae type.

FIG. 3 shows a corresponding micrograph of a diatomaceous earth of the LCS-3 type from EP Minerals LLC, Reno, USA derived from cylindrical siliceous algae of the Melosira granulata type.

FIG. 4 shows a scanning electron micrograph of a corresponding diatomaceous earth (Diatomite 1) from Mineral Resources Ltd., Lima, Peru, which is based predominantly on rod-shaped siliceous algae.

### DETAILED DESCRIPTION OF THE INVENTION

A preferred embodiment of the invention is a catalyst for the oxidation of SO₂ to SO₃, which comprises active substance comprising vanadium, alkali metal compounds and sulfate applied to a support comprising naturally occurring diatoamceous earth, wherein the support comprises at least two different naturally occurring uncalcined diatomaceous earths which differ in terms of the structure type of the siliceous algae from which they are derived, where the different structure types are selected from the group consisting of plate-shaped, cylindrical and rod-shaped structure types.

The catalysts of the invention have significantly better properties, in particular an improved mechanical stability, than the catalysts known hitherto.

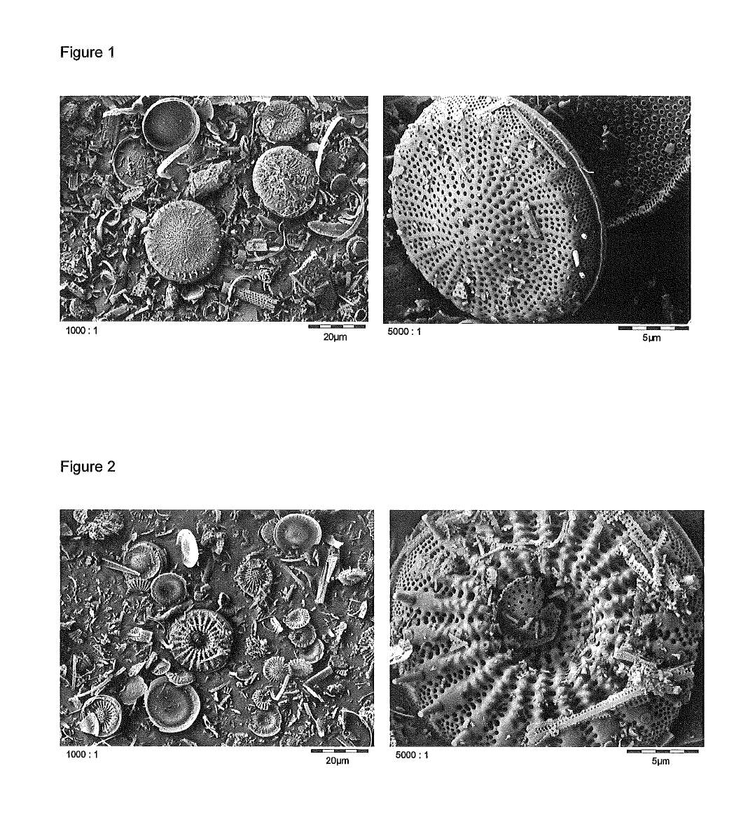

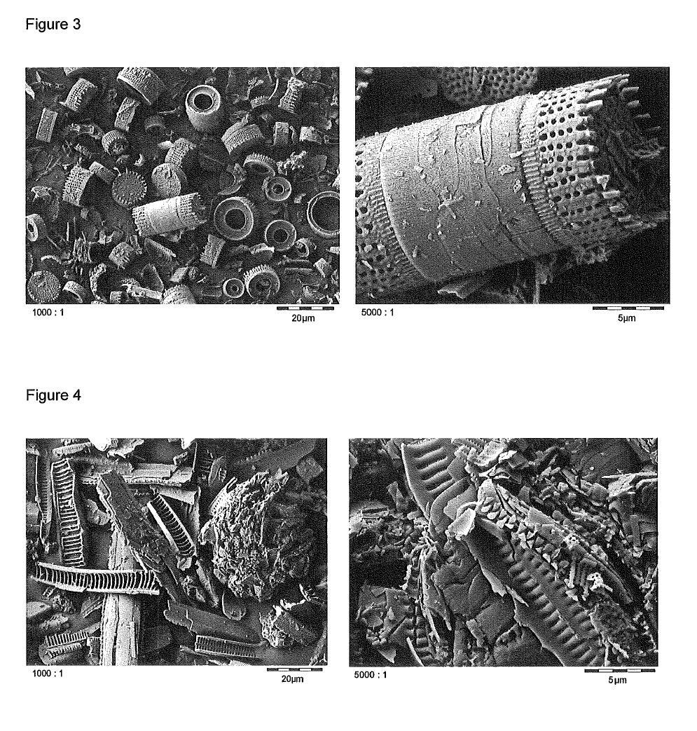

For the purposes of the invention, a diatomaceous earth is assigned to the structure type of the siliceous alga from which it is derived, with the form of the parent siliceous alga being able to be predominantly recognized in an electron micrograph. Examples of electron micrographs of various plate-shaped, cylindrical or rod-shaped diatomaceous earths which display predominantly one form of siliceous alga are shown in FIGS. 1 to 4.

Diatomaceous earths suitable for producing the catalysts of the invention should have a content of aluminum oxide Al₂O₃ of less than 5% by weight, preferably less than 2.6% by weight and in particular less than 2.2% by weight. Their content of iron(III) oxide Fe₂O₃ should be less than 2% by weight, preferably less than 1.5% by weight and in particular less than 1.2% by weight. Their total content of alkaline earth metal oxides (magnesium oxide MgO+calcium oxide CaO) should be less than 1.8% by weight, preferably less than 1.4% by weight and in particular less than 1.0% by weight.

For the purposes of the present invention, uncalcined diatomaceous earth is a diatomaceous earth which has not been treated at temperatures above 500° C., preferably not above 400° C. and in particular not above 320° C., before mixing with the active components. A characteristic feature of uncalcined diatomaceous earth is that the material is essentially amorphous, i.e. the content of cristobalite is <5% by weight, preferably <2% by weight and particularly preferably <1% by weight (determined by X-ray diffraction analysis).

The median volume-based pore diameter (i.e. the pore diameter above and below which in each case 50% of the total pore volume is found, determined by means of mercury porosimetry) of the various diatomaceous earths which can be used for the purposes of the present invention should be in the range from 0.1 μm to 10 μm, preferably from 0.5 μm to 9 μm and in particular from 0.7 μm to 7 μm. The median volume-based pore diameter of mixtures according to the invention of uncalcined diatomaceous earths should be in the range from 0.5 μm to 9 μm, preferably from 0.8 to 7 μm and in particular from 0.9 to 5 μm. Here, the shape of the pore size distribution of the mixtures according to the invention can deviate significantly from that of the individual diatomaceous earths. Oligomodal or bimodal pore distributions or monomodal pore distributions having pronounced shoulders can result from some combinations of the various diatomaceous earths. Setting of a particular median volume-based pore diameter within the above-described limits by mixing different diatomaceous earths in various ratios is possible in principle.

In the production of the sulfuric acid catalysts according to the invention, partial breaking-up of the diatom structures occurring as a result of mechanical stress during the mixing step or the shaping step and also the application of the active composition to the diatomaceous earth support leads to a shift in the median volume-based pore diameters, so that the resulting catalyst generally has a significantly lower median volume-based pore diameter than the parent support. The median volume-based pore diameter of the sulfuric acid catalysts of the invention is in the range from 0.1 μm to 5 μm, preferably from 0.2 μm to 4 μm and in particular from 0.3 μm to 3.2 μm, with the shape of the pore size distribution of the catalysts whose supports are based on mixtures of uncalcined diatomaceous earths being able to be set via the type and ratio of the various diatomaceous earths, so that oligomodal or bimodal pore size distributions or monomodal pore size distributions having pronounced shoulders can also result here.

Particularly good catalysts are obtained when using a support material in which each of the different diatomaceous earths comprised is present in a proportion based on the total mass of the support of at least 10% by weight, preferably at least 15% by weight and particularly preferably at least 20% by weight.

The catalysts of the invention generally have a cutting hardness of at least 60 N, preferably at least 70 N and particularly preferably at least 80 N. Their abrasion is generally <4% by weight, preferably <3% by weight. Their tapped density is generally in the range from 400 g/l to 520 g/l, preferably in the range from 425 g/l to 500 g/l. Their porosity (determined by means of the toluene absorption of the material) is at least 0.38 ml/g, preferably at least 0.4 ml/g and particularly preferably at least 0.45 ml/g.

To determine the tapped density of a catalyst, about 1 liter of the shaped bodies are introduced via a vibrating chute into a straight plastic measuring cylinder having a volume of 2 liters. This measuring cylinder is located on a tamping volumeter which taps over a defined time and thus compacts the shaped bodies in the measuring cylinder. The tapped density is finally determined from the weight and the volume.

The characteristic physical catalyst properties cutting hardness, abrasion and porosity were determined by methods analogous to those described in EP 0019174. The catalytic activity was determined by the method described in DE 4000609. A commercial catalyst as described in DE 4000609, example 3, was used as reference catalyst.

The invention further provides a process for producing the above-described catalysts for the oxidation of SO₂ to SO₃, wherein a support comprising at least two different naturally occurring uncalcined diatomaceous earths which differ in terms of the structure type of the siliceous algae from which they are derived is admixed with a solution or suspension comprising vanadium, alkali metal compounds and sulfate.

A preferred embodiment of the invention is a process for producing the above-described catalysts for the oxidation of SO₂ to SO₃, wherein a support comprising at least two different naturally occurring uncalcined diatomaceous earths which differ in terms of the structure type of the siliceous algae from which they are derived, where the various structure types are selected from the group consisting of plate-shaped, cylindrical and rod-shaped structure types, is admixed with a solution or suspension comprising vanadium, alkali metal compounds and sulfate.

The invention further provides a process for the oxidation of SO₂ to SO₃ using the above-described catalysts. In a preferred embodiment of the invention, a gas mixture comprising oxygen and sulfur dioxide SO₂ is brought into contact at temperatures in the range from 340 to 680° C. with the catalyst, with at least part of the sulfur dioxide being converted into sulfur trioxide SO₃.

### EXAMPLES

All diatomaceous earths used in the following comprise less than 4% by weight of aluminum oxide Al₂O₃, less than 1.5% by weight of iron(III) oxide Fe₂O₃ and less than 1.0% by weight of alkaline earth metal oxides (sum of magnesium oxide MgO and calcium oxide CaO). The proportion of crystalline cristobalite was below the detection limit of about 1% by weight. The loss on ignition at 900° C. was typically in the range from 5 to 12% by weight.

The synthesis of all catalysts was carried out by a method based on DE 4000609, example 3. The determination of the catalyst activity was likewise carried out by a method based on that described in DE 4000609.

### Example 1

### Comparative Example

3.51 kg of a diatomaceous earth of the Masis type from Diatomite SP CJSC, Armenia, were mixed with a suspension composed of 1.705 kg of 40% strength KOH, 0.575 kg of 25% strength NaOH and 0.398 kg of 90% strength ammonium polyvanadate and 2.35 kg of 48% strength sulfuric acid. 250 g of a 7.4% strength by weight aqueous starch solution were subsequently added, the mixture was intensively mixed and extruded to give 11×5 mm star extrudates. These extrudates were subsequently dried at 120° C. and calcined at 650° C.

### Example 2

### Comparative Example

3.926 kg of a diatomaceous earth of the MN type from EP Minerals LLC, Reno, USA, were mixed with a suspension composed of 1.701 kg of 40% strength KOH, 0.563 kg of 25% strength NaOH and 0.398 kg of 90% strength ammonium polyvanadate and 2.35 kg of 48% strength sulfuric acid. 250 g of a 7.4% strength by weight aqueous starch solution were subsequently added, the mixture was intensively mixed and extruded to give 11×5 mm star extrudates. These extrudates were subsequently dried at 120° C. and calcined at 650° C.

The catalyst produced in this way had a porosity of 0.49 ml/g. The cutting hardness was 74.3 N, the abrasion was 3.0% by weight and the bulk density was 431 g/l (cf. table 1).

### Example 3

### Comparative Example

3.565 kg of a diatomaceous earth of the Diatomite 1 type from Mineral Resources Co., Lima, Peru were mixed with a suspension composed of 1.666 kg of 40% strength KOH, 0.559 kg of 25% strength NaOH and 0.396 kg of 90% strength ammonium polyvanadate and 2.35 kg of 48% strength sulfuric acid. 250 g of a 7.4% strength by weight aqueous starch solution were subsequently added, the mixture was intensively mixed and extruded to give 11×5 mm star extrudates. These extrudates were subsequently dried at 120° C. and calcined at 650° C.

### Example 4

### Comparative Example

3.496 kg of a diatoamceous earth of the LCS-3 type from EP Minerals LLC were mixed with a suspension composed of 1.711 kg of 40% strength KOH, 0.587 kg of 25% strength NaOH and 0.398 kg of 90% strength ammonium polyvanadate and 2.35 kg of 48% strength sulfuric acid. 250 g of a 7.4% strength by weight aqueous starch solution were subsequently added, the mixture was intensively mixed and extruded to give 11×5 mm star extrudates. These extrudates were subsequently dried at 120° C. and calcined at 650° C.

### Examples 5 and 6

The catalyst was produced by a method analogous to examples 1 to 4 using a mixture of diatomaceous earths comprising 70% by weight of the MN type from EP Minerals LLC and 30% by weight of the Diatomite 1 type from Mineral Resources Co. (example 5) or using a mixture of diatomaceous earths comprising 70% by weight of the LCS-3 type from EP Minerals LLC and 30% by weight of the Diatomite 1 type from Mineral Resources Co. (example 6). The composition of the actual active component was not varied except for slight process-related fluctuations (deviations<5% relative; SO₄<9% relative).

### Example 7

The catalyst was produced by a method analogous to examples 1 to 4 using a mixture of diatomaceous earths comprising 20% by weight of the MN type from EP Minerals LLC, 50% by weight of the Masis type from Diatomite SP CJSC and 30% by weight of the Diatomite 1 type from Mineral Resources Co. The composition of the actual active component was not varied except for slight process-related fluctuations (deviations<5% relative; SO₄<9% relative).

### Example 8

2.753 kg of a diatomaceous earth of the MN type from EP Minerals LLC was mixed with a suspension composed of 0.956 kg of Cs₂SO₄, 1.394 kg of 47% strength KOH and 0.417 kg of 90% strength ammonium polyvanadate and 1.906 kg of 48% strength sulfuric acid. 177 g of a 10.68% strength by weight aqueous starch solution were subsequently added, the mixture was intensively mixed and extruded to give 11×5 mm star extrudates. These extrudates were subsequently dried at 120° C. and calcined at 510° C.

### Example 9

3.906 kg of a diatomaceous earth of the LCS-3 type from EP Minerals LLC were mixed with a suspension composed of 1.381 kg of Cs₂SO₄, 1.999 kg of 47% strength KOH and 0.595 kg of 90% strength ammonium polyvanadate and 2.769 kg of 48% strength sulfuric acid. 250 g of a 10.68% strength by weight aqueous starch solution were subsequently added, the mixture was intensively mixed and extruded to give 11×5 mm star extrudates. These extrudates were subsequently dried at 120° C. and calcined at 510° C.

### Example 10

The catalyst was produced by a method analogous to example 8 and example 9 using a mixture of diatomaceous earths comprising 50% by weight of the MN type from EP Minerals LLC, 20% by weight of the Celite 400 type from Lehmann & Voss & Co., Hamburg, and 30% by weight of the Diatomite 1 type from Mineral Resources Co. The composition of the actual active component was not varied except for slight process-related fluctuations (deviations <5% relative; SO₄<9% relative).

### Example 11

The catalyst was produced by a method analogous to example 8 and example 9 using a mixture of diatomaceous earths comprising 30% by weight of the LCS-3 type from EP Minerals LLC, 30% by weight of the Masis type from Diatomite SP CJSC and 40% by weight of the Diatomite 1 type from Mineral Resources Co. The composition of the actual active component was not varied except for slight process-related fluctuations (deviations<5% relative; SO₄<9% relative).

The combination of significantly improved mechanical properties with comparable or increased catalytic activities over the entire temperature range examined displayed by the catalysts produced according to examples 5, 6, 7 and 10 and 11 illustrates the superiority of the catalysts of the invention.

TABLE 1
Pore volume, cutting hardness, abrasion, tapped density and catalytic properties of the catalysts produced in examples 1 to 11.

| | Composition of | | Cutting | | Tapped | Activity at | Activity at | Activity at | Activity at | Activity at |
|---|---|---|---|---|---|---|---|---|---|---|
| | the support | Porosity | hardness | Abrasion | density | 390° C. | 400° C. | 410° C. | 430° C. | 450° C. |
| Example | [% by weight] | [ml/g] | [N] | [% by weight] | [ml/g] | [%] | [%] | [%] | [%] | [%] |
| 1 | P/C/R = 100/0/0 | 0.5 | 76.9 | 3.4 | 463 | 210 | 180 | 160 | 75 | 60 |
| 2 | P/C/R = 0/100/0 | 0.49 | 74.3 | 3.0 | 431 | 160 | 150 | 100 | 65 | 60 |
| 3 | P/C/R = 0/0/100 | 0.36 | 150.2 | 1.5 | 560 | 150 | 155 | 155 | 65 | 55 |
| 4 | P/C/R = 0/100/0 | 0.6 | 49.9 | 13.1 | 394 | — | — | 170 | 75 | 65 |
| 5 | P/C/R = 0/70/30 | 0.48 | 81.9 | 1.7 | 472 | 205 | 220 | 160 | 65 | 50 |
| 6 | P/C/R = 0/70/30 | 0.51 | 70.5 | 2.6 | 473 | 390 | 325 | 200 | 80 | 70 |
| 7 | P/C/R = 50/20/30 | 0.47 | 83.4 | 2.6 | 436 | 235 | 195 | 190 | 95 | 75 |
| 8 1) | P/C/R = 0/100/0 | 0.39 | 72.3 | 3.7 | 523 | 110 | 115 | 105 | 90 | 95 |
| 9 1) | P/C/R = 0/100/0 | 0.5 | 53.3 | 4.9 | 413 | — | — | — | — | — |
| 10 1) | P/C/R = 20/50/30 | 0.38 | 74.2 | 2.2 | 504 | 145 | 125 | 100 | 100 | 100 |
| 11 1) | P/C/R = 30/30/40 | 0.39 | 76.1 | 3.7 | 448 | 120 | 115 | 115 | 105 | 105 |

1) Cs-comprising sulfuric acid catalyst
P = plate-shaped structure type, C = cylindrical structure type, R = rod-shaped structure type

1.-7. (canceled)

8. A catalyst for the oxidation of SO₂ to SO₃, which comprises active substance comprising vanadium, alkali metal compounds and sulfate applied to a support comprising naturally occurring diatomaceous earths, wherein the support comprises at least two different naturally occurring uncalcined diatomaceous earths which differ in terms of the structure type of the siliceous algae from which they are derived.

9. The catalyst according to claim 8, wherein the different structure types are selected from the group consisting of plate-shaped, cylindrical and rod-shaped structure types.

10. The catalyst according to claim 8, wherein each of the different diatomaceous earths comprised in the support is present in a proportion based on the total mass of the support of at least 10% by weight.

11. A process for producing a catalyst for the oxidation of SO₂ to SO₃, which comprises admixing a support comprising at least two different naturally occurring uncalcined diatomaceous earths which differ in terms of the structure type of the siliceous algae from which they are derived, with a solution or suspension comprising vanadium, alkali metal compounds and sulfate.

12. A process for producing a catalyst for the oxidation of SO₂ to SO₃, which comprises applying active substance comprising vanadium, alkali metal compounds and sulfate to a support comprising at least two different naturally occurring uncalcined diatomaceous earths which differ in terms of the structure type of the siliceous algae from which they are derived.

13. The process according to claim 11, wherein the different structure types are selected from the group consisting of plate-shaped, cylindrical and rod-shaped structure types.

14. A process for the oxidation of SO₂ to SO₃ which comprises utilizing the catalyst according to claim 8.

15. The process according to claim 14, wherein a gas mixture comprising oxygen and sulfur dioxide SO₂ is brought into contact at temperatures in the range from 340 to 680° C. with the catalyst.
